(19) United States
(12) Patent Application Publication
(10) Pub. No.: US 2004/0253999 A1
(43) Pub. Date: Dec. 16, 2004

(54) Attachability enhanced wireless phone

(76) Inventor: Sergio Castaneda JR., Gary, IN (US)

Correspondence Address: Sergio Castaneda Jr., 2554 E. Oakwood Drive, Gary, IN, 46406, US

(21) Appl. No.: 10/460,840

(22) Filed: Jun. 16, 2003

(51) Int. Cl. H04M 1/00; H04B 1/38

(52) U.S. Cl. 455/575.2; 455/575.1

(57) ABSTRACT

A wireless phone made attachable to the user's head using an ear loop and a mouth hook.

### CROSS-REFERENCE TO RELATED APPLICATIONS

Not Applicable

### STATEMENT REGARDING RECENT FEDERALLY SPONSORED RESEARCH OR DEVELOPMENT

Not Applicable

### BACKGROUND OF THE INVENTION

1. Field of the Invention

The present invention relates to portable or cellular phones enhanced by attachability to the user's head via ear loops and a mouth hook attached directly to said phones or to their cases.

2. Description of the Prior Art

No similar phone device using earloops and a mouth hook has been found.

### BRIEF SUMMARY OF THE INVENTION

It is the object of the invention to provide attachability of any potable or cellular phone to the user's head using ear loops and a mouth hook facilitating hands-free operation. Hitherto such operation has been possible with plugged wire headsets which are troublesome to carry and break often. The mouth hook is extended from the bottom of the phone. The phone speaker is positioned over the user's ear as the ear loop is looped over that ear, then the mouth hook is comfortably inserted into the corner of the user's mouth, further attaching the phone to the user's head, and hands-free communication may begin.

### BRIEF DESCRIPTION OF DRAWINGS

FIG. 1 is a top view of the attachability enhanced wireless phone opened.

FIG. 2 is a side view of the attachability enhanced wireless phone opened the mouth hook rotated to the use position.

### DETAILED DESCRIPTION OF DRAWINGS

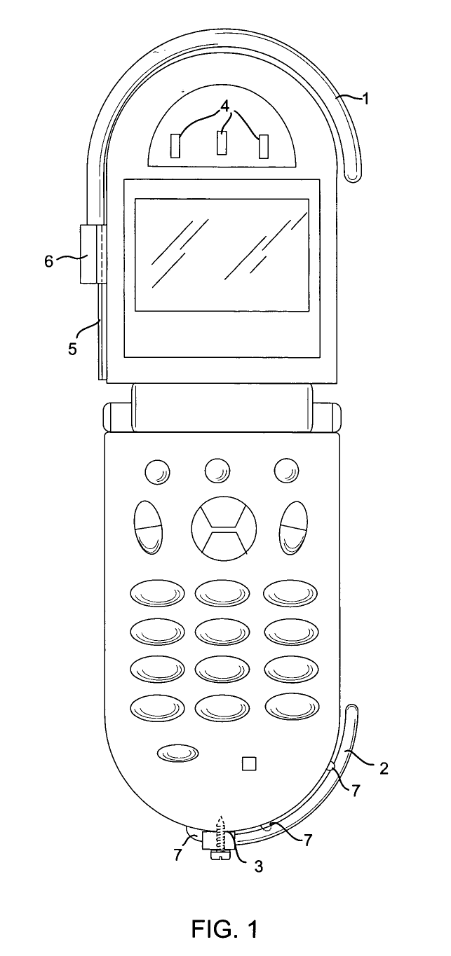

FIG. 1 displays the top view of the attachability enhanced wireless phone opened.

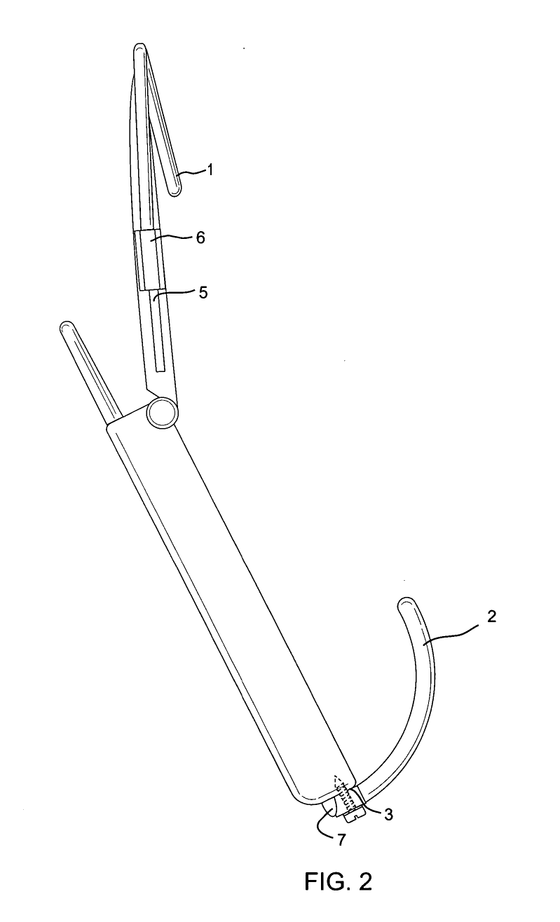

When the phone is placed to the user's head ear loop 1 is looped over the user's ear as it hugs the ear by a spring assisted hinge 6, and having a vertical sliding and locking attachment to rail 5 at the side of said phone that proper alignment may be made and maintained between the user's ear and the phone speaker 4. Mouth hook 2 is a rod conforming to the bottom and corner of the phone rotateably connected proximal to said phone's bottom center 3 and by use of detents 7 is locked in the unused position parallel to the phone's keypad face to be manually rotated 90 degrees upward and locked in the use position perpendicular to the phones keypad face 2 of FIG. 2 to be inserted into the corner of the user's mouth to further attach said phone to the user's head for hands-free operation.

I claim:

1. A wireless phone made attachable to the user's head by an ear loop emanating from either or each side of and near the top of said phone to engage the user's ear, and a rod emanating proximal to the bottom of said phone to engage the user's mouth.

2. The phone of claim one comprising ear loops with spring assisted hinges.

3. The phone of claim one further comprising a rail on which the hinges may be adjusted up or down.

4. The phone of claim one further comprising a rod conforming to the bottom and corner of said phone rotateably connected to its bottom end and by use of detents locked in the unused position parallel to the keypad face to be manually rotated 90 degrees upward and locked in a use position perpendicular to said keypad face.

5. The phone of claim one comprising a case equipped with ear loops right and left attached to said case on respective sides to engage the user's ear and a rod emanating proximal to the bottom of said case to engage the user's mouth.
